(19) United States
(12) Patent Application Publication
(10) Pub. No.: US 2006/0036572 A1
(43) Pub. Date: Feb. 16, 2006

(54) Method and system to control access to content accessible via a network

(75) Inventor: Balas Natarajan Kausik, Los Gatos, CA (US)

Correspondence Address: Schwegman, Lundberg, Woessner & Kluth, P.A., P.O. Box 2938, Minneapolis, MN, 55402, US

(73) Assignee: Cisco Technology, Inc.

(21) Appl. No.: 11/195,882

(22) Filed: Aug. 2, 2005

Related U.S. Application Data
(60) Provisional application No. 60/598,301, filed on Aug. 3, 2004.

(51) Int. Cl. G06F 17/30

(52) U.S. Cl. 707/1

(57) ABSTRACT

Described herein are a method and a system to control access to content accessible via a network. The method may include receiving a Uniform Resource Locator (URL) from a client machine and submitting a search request based upon the URL to a search engine. The method includes receiving a search result including associated URL data and comparing the associated URL data with reference data. Access may be selectively denied to the content based on the comparison.

### RELATED APPLICATION

This application claims priority from a provisional application entitled: “Method And Apparatus For Content Filtering Using Search Engine”, filed on Aug. 3, 2004, Ser. No. 60/598,301, the entire contents of which is included herein by reference.

### TECHNICAL FIELD

This application relates to a method and system to control access to content accessible via a network.

### BACKGROUND

Many organizations desire to limit the type of internet content that is viewable from computer browsers installed within the organization. Specifically, many organizations prefer to prohibit the viewing of pornography and other socially objectionable content from computers installed within the organization. For example, a high-school may desire to block the viewing of pornographic material on campus. Also, a parent may choose to block content unsuitable for small children, and this block may be facilitated by an Internet Service Provider. In addition, a global corporation may seek to block socially objectionable content at any of its offices.

A filtering product may be installed at a firewall, to prevent access to such content. Commercial products currently available for this purpose typically block black-listed Uniform Resource Locators (URLs), where a black list of URLs is maintained as a service by the vendor of the product. Limitations of such products include a manually generated black list goes rapidly out-of-date and inadequacy to provide coverage across many languages.

### SUMMARY

A method and system to control access to content accessible via a network.

Other features will be apparent from the accompanying drawings and from the detailed description that follows.

### BRIEF DESCRIPTION OF DRAWINGS

Embodiments of the present invention are illustrated by way of example and not limitation in the figures of the accompanying drawings, in which like references indicate similar elements and in which:

FIG. 1 illustrates a network diagram depicting a system, according to an example embodiment.

FIG. 2 illustrates a block diagram of one or more applications associated with a web proxy, according to an example embodiment.

FIG. 3 illustrates a high-level entity-relationship diagram, illustrating various tables that may be maintained within one or more databases, according to an example embodiment.

FIG. 4 illustrates a search result set, according to an example embodiment.

FIG. 5 illustrates a flowchart of a method, according to an example embodiment.

FIG. 6 illustrates a diagrammatic representation of an example machine in the form of a computer system within which a set of instructions, for causing the machine to perform any one or more of the methodologies discussed herein, may be executed.

### DETAILED DESCRIPTION

In an example embodiment, there is provided a method and system to control access to content accessible via a network. The method and the system to receive a Uniform Resource Locator (URL); to submit a search request based upon the URL; to receive a search result including associated URL data; to compare the associated URL data with reference data; and to selectively deny access to the content based on the comparison.

“Associated URL data” as used herein may be selected from a group including a category, class, classification, cognomen, compellation, denomination, description, epithet, identification, key word, label, mark, moniker, naming, nomen, style, title, designation, department, division, grade, group, grouping, head, heading, kind, league, level, list, section, sort, type, and the like, which may be associated with the URL and/or the search result.

In the following detailed description of example embodiments, reference is made to the accompanying drawings which form a part hereof, and in which is shown by way of illustration specific embodiments in which the example method and system may be practiced. It is to be understood that other embodiments may be utilized and structural changes may be made without departing from the scope of this description.

### EXAMPLE PLATFORM ARCHITECTURE

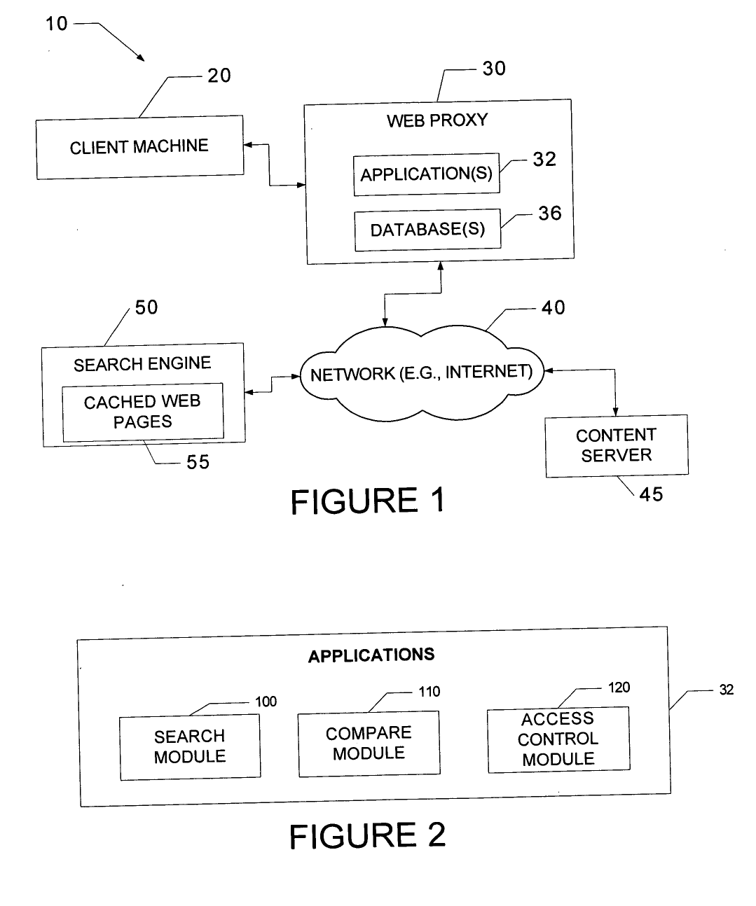

FIG. 1 illustrates a network diagram depicting a system 10, according to an example embodiment. A client machine 20 may access, through a web proxy 30, a network 40. Via the network 40, the client machine 20 may access a content server 45 and a search engine 50. The network 40 may, for example, be the Internet, a public or private telephone network (wired or wireless), a private wireless network using technologies such as Bluetooth or IEEE 802.11x or other standards, or any other network.

The client machine 20 may be a laptop computer, a desktop computer, a tablet PC, a set-top box (STB), a Personal Digital Assistant (PDA), wireless devices such as a Smartphone, or a cellular telephone, or the like. The client machine 20 may be browser-enabled. In an example embodiment, the client machine 20 may include a web client and a programmatic client. The web client may be a browser, such as the Internet Explorer® browser by Microsoft®, Firefox® browser by Mozilla®, or any other browser. The programmatic client may include one or more module(s) for executing on the client machine to facilitate communication, and/or searching features with the network 40.

The web proxy 30 may include a filter to selectively filter content requested by the client machine 20. The web proxy 30 may also include one or more application(s) 32, as described in more detail with respect to FIG. 2. The various applications of the web proxy 30 may also be implemented as standalone software programs, which do not necessarily have networking capabilities.

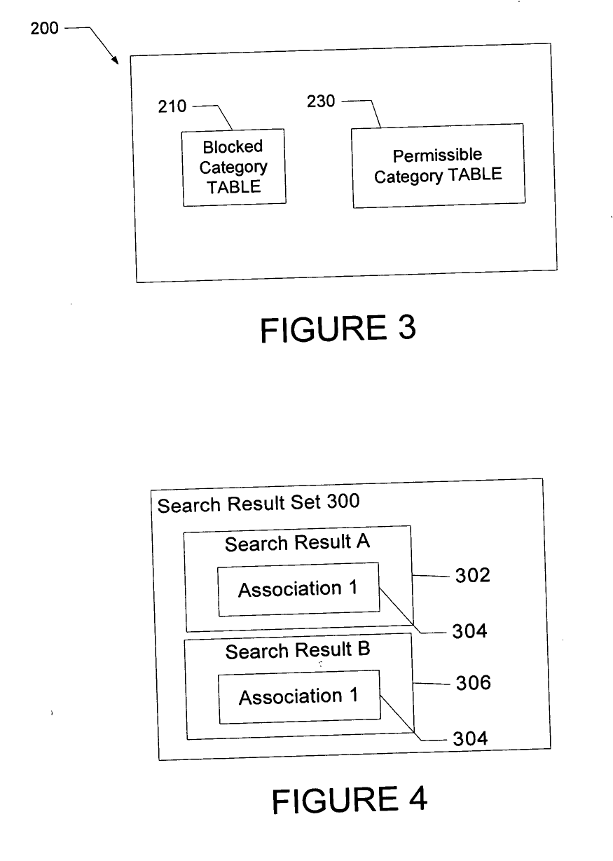

The web proxy 30 may access one or more database(s) 36 having reference data (e.g., reference URL data). The database(s) 36 may be a part of the web proxy 30, as illustrated, or may alternatively be located elsewhere in the network, separate from the web proxy. The database(s) 36 may store a plurality of associations, such as reference key words, that may be associated with at least one Uniform Resource Locator (URL), as described in more detail with regard to FIG. 3.

The search engine 50 may search documents of the content server 45 and/or may search cached web pages 55 of the search engine upon receiving a search request. The search request may be, for example, an Internet search request from a user via a web browser of the client machine 20 or for example, an Internet search request from the web proxy 30. Large commercial search engines may be used, such as Yahoo® and Google®. The search engine may search based on search terms, such as a Uniform Resource Locator (URL), for any relevant web pages.

The example embodiments described herein may be implemented on one or more computers that are connected by a network. Such computers may or may not be in a distributed computing environment. Further, the system 10 may find applications in a client-server architecture, as well as in a distributed, or peer-to-peer, architecture system.

### EXAMPLE APPLICATION(S)

FIG. 2 illustrates a block diagram of one or more applications 32 associated with the web proxy 30, according to an example embodiment. One skilled in the art will appreciate that applications 32, including a search module 100, a compare module 110, and an access control module 120, may be separate from the web proxy 30, or part of the web proxy 30, as shown.

As mentioned above, the application(s) 32 may include one or more search module(s) 100. The search module 100 may submit a search request to the search engine 50 based upon a received URL. The web proxy 30 may receive the URL from a user of the client machine 20. The URL may be received by the web proxy 30 when the user clicks on a web link, selects a web bookmark, types in a web address, or any other method of retrieving a particular web page.

The search engine 50 may search cached World Wide Web documents 55, the content server 45 based upon the search request, or any other content. The web proxy 30 may receive search results based on the URL search, including a search result set as shown for example in FIG. 4. The search result set may include search results and associated URL data, as described herein. Thus, in an example embodiment, a “reverse search” is conducted where a URL is provided in a search query to obtain key words (associated URL data) as opposed to a regular search where a key word is provided to locate a relevant URL.

Further, as mentioned above, the application(s) 32 may include one or more comparison or compare module(s) 110. The compare module 110 may compare the associated URL data (the search results obtained in response to the search query using the URL) with the reference data of the database 36.

The application(s) 32 may include one or more access control module(s) 120. Based upon the comparison by the compare module 110, the access control module may selectively deny user access to the content based on the comparison. In particular, the user may receive an indication that the particular URL is blocked when the associated URL data corresponds to objectionable content identified by the reference data. Alternatively, the user may receive the web page or site associated with the URL requested when the association URL data does not correspond to objectionable content of the reference data. For example, when a request to a URL is received from the client machine 20, and the URL is not associated with objectionable content, the proxy server 40 may communicate the request to the requested URL. However, when the URL is associated with objectionable content, the access control module 120 blocks or filters the request so that the client machine is blocked or barred from accessing content associated with the URL. In an embodiment, the reference data may be defined or modified by a system administrator, for example, a system administrator of a network to which the client machine 20 is connected.

### EXAMPLE DATA STRUCTURES

FIG. 3 illustrates a high-level entity-relationship diagram, illustrating various tables 200 that may be maintained within the one or more databases 36 according to an example embodiment. The tables 200 may be utilized by and support the application(s) 32 of the web proxy 30. The tables 200 may store reference data. For example, the reference data may include a plurality of associations, such as a directory including categories and/or key words, which may be associated with various web sites (e.g., a web site that provides material that is objectionable based on public policy, company policy, age of the user, or the like).

The tables 200 may include one or more blocked category table(s) 210 and/or one or more permissible category table(s) 230. In some applications, the blocked category table 210 is maintained and updated, and used by the compare module 110. The blocked category table 210 may be used to block content to the user, when the associated URL data corresponds to any reference data included in table 210, and/or the permissible category tables 230 may be used to block content to the user when the associated URL data does not correspond to any reference data in table 230.

The blocked category table 210 and/or the permissible category table 230 may receive the reference data, including categories, from a variety of sources. Sources for the reference data (such as objectionable content) of the tables may include reference data specified by an administrator, reference data from previous search results and associated URL data, language dictionaries that categorize scatological words, etc.

### EXAMPLE SEARCH RESULT SET

FIG. 4 illustrates a search result set 300, according to an example embodiment. The search result set 300 may include the result of the search from the search module 100 based upon the URL received from the user.

The search result set 300 may include a search result A 302 having an association 1 304, such as associated URL data. The search result A 302 may include a web link and the associated URL data may categorize the web link according to topic and/or key words. Similarly, the search result set 300 may also include a search result B 306 that may also have the association 1 304. The search result B 306, in this example, may be for a different web link, but may be categorized under the same directory.

The association 1 304, such as the associated URL data, may be compared to the reference data of the table 200 by the compare module 110.

### EXAMPLE FLOW CHART

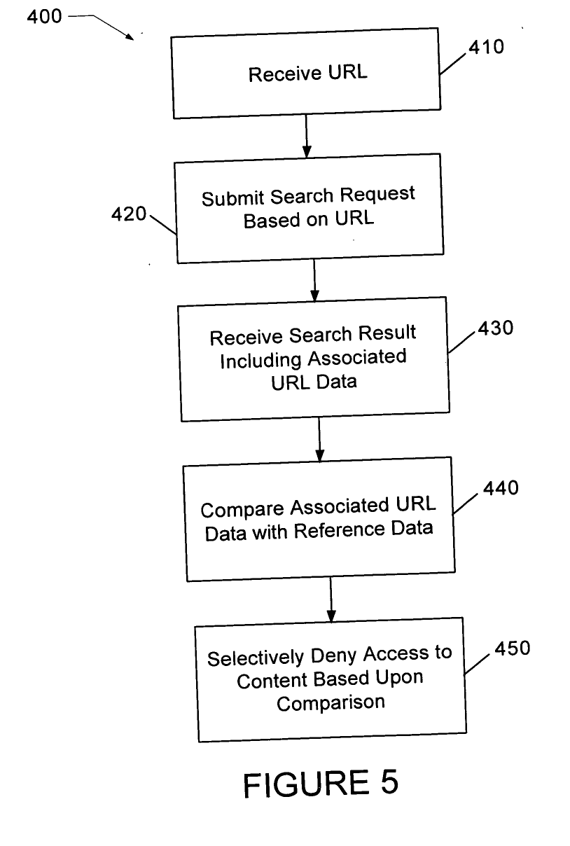

FIG. 5 illustrates a flow chart of a method 400, according to an example embodiment.

At block 410, a Uniform Resource Locator (URL) may be received. The URL may be received from a user requesting access to content, using a web browser, via the network 40. The user may be attempting to access the Internet via a local area network. The web proxy 30 may receive the URL in response to a user request, for example, entered by the user via a web browser.

At block 420, a search request may be submitted to any search engine available on the Internet. The search request may be based on search criteria including the URL received from the user. The search may include searching the cached World Wide Web documents 55, the content server 45, or any other content available on the Internet to obtain a search result set. The web proxy 30 may submit the search request to the search engine 50.

At block 430, search results including associated URL data may be received. The search results may be received by the web proxy 30.

At block 440, the associated URL data may be compared with the reference data. The compare module 110 may make the comparison.

At block 450, based on the comparison, access to the content may be selectively denied. The access control module 120 may selectively deny access.

The selectively denying access may include blocking user access to the URL providing the content when the associated URL data corresponds with the reference data. The selectively denying access may include denying a request from the web browser to access the URL. If the URL requested by the user is to be blocked, the web proxy 30 may send the user an error page indicating that the request was blocked.

The user request for the content may be forwarded to the content server when the request is not denied based on the comparison between the associated URL data and the reference data. The response of the content server may also then be forwarded to the browser of the client machine.

The search result and associated URL data may additionally be cached in the database tables of the web proxy for subsequent use, regardless of access outcome.

In an example implementation, the web proxy 30 may add browser scripting to the content forwarded to the user. The browser scripting may support a search feature for selected document text. The search feature may be associated with the browser or programmatic client of the client machine 20. The user may highlight and select any portion of text in the content. The text may be selected by activating a search function or feature, such as via a right click of the mouse or other methods (such as through a menu accessed through a button on the browser, and/or a user input button, or a key, such as a function key F1 on a keyboard). Upon selection of the search function, a search request based on the selected text may be submitted. The search request may access the search engine via the web proxy 30 as described herein. The search may be a keyword search and/or a selected text search.

In an example implementation, the web proxy or filter includes the ability to examine and filter out objectionable content prior to entry into an organization's network. The selective URL access may be automated with the web proxy, and automatically updated with corresponding URL updates associated with the search engines used in the search.

The web proxy 30 may thus use a standard Internet search engine in reverse to categorize user-requested URLs. Specifically, search engines are typically used by entering a list of key words, and receiving a list of URLs in return. The web proxy may submit a search based upon the URL requested by the user, and receive search results in return. The search result may include key words that categorize the URL, and these key words may then be used by the web proxy to decide whether to block access to the associated URL content.

### EXAMPLE COMPUTER SYSTEM

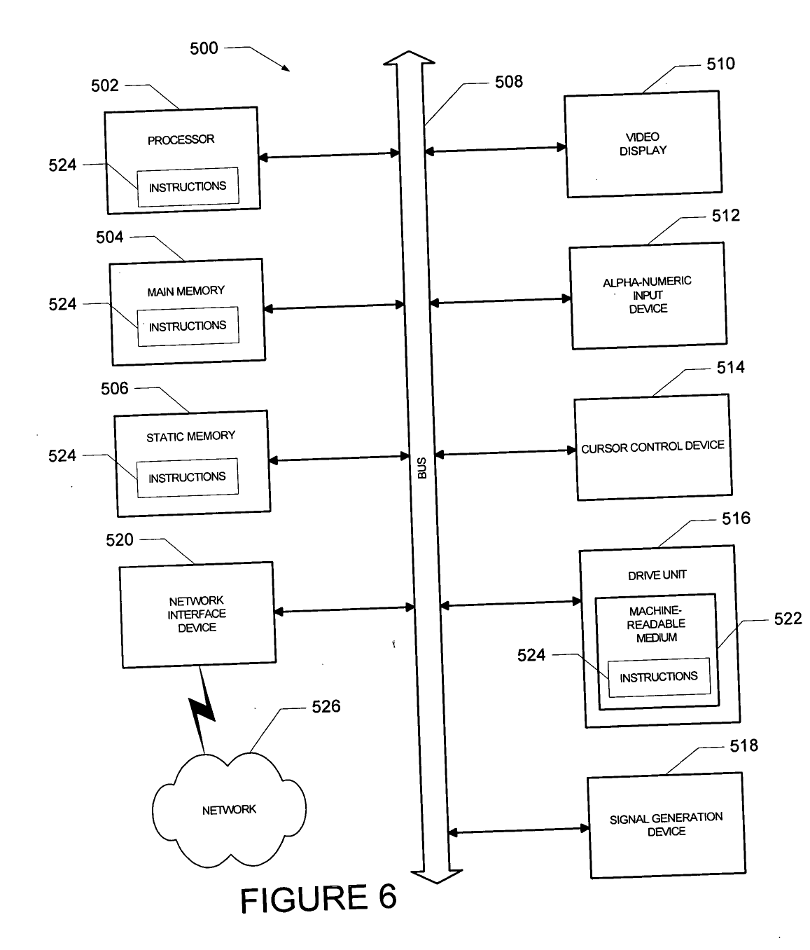

FIG. 6 shows a diagrammatic representation of machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such medium may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method to control access to content accessible via a network, the method comprising:
receiving a Uniform Resource Locator (URL);
submitting a search request based upon the URL;
receiving a search result including associated URL data;
comparing the associated URL data with reference data; and
selectively denying access to the content based on the comparison.

2. The method of claim 1 wherein the selectively denying access includes blocking access to the URL when the associated URL data corresponds with the reference data.

3. The method of claim 1 further comprising forwarding a request to the URL when the request is not denied based on the comparison between the associated URL data and the reference data.

4. The method of claim 1 wherein the reference data includes a list of reference key words.

5. The method of claim 1 wherein the associated URL data includes key words associated with the URL.

6. The method of claim 1 wherein the selectively blocking access includes denying a request from a web browser to access the URL.

7. The method of claim 1 further comprising caching the search result and the associated URL data for subsequent use.

8. The method of claim 1 wherein the reference data includes objectionable content specifiable by an administrator.

9. The method of claim 1 wherein the network is the Internet, the method further comprising receiving the URL at a web proxy from a client machine accessing the Internet via a local area network.

10. The method of claim 1 wherein the associated URL data includes at least one selected from a group including a category, class, classification, cognomen, compellation, denomination, description, epithet, identification, key word, label, mark, moniker, naming, nomen, style, title, designation, department, division, grade, group, grouping, head, heading, kind, league, level, list, section, sort, and a type.

11. A machine-readable medium embodying instructions which, when executed by a machine, cause the machine to perform the method of claim 1.

12. A system to control access to content accessible via a network, the system comprising:
a web proxy to receive a Uniform Resource Locator (URL), to submit a search request to a search engine based upon the URL, and to receive a search result including associated URL data from the search engine;
a compare module to compare the associated URL data with reference data; and
an access control module to selectively deny access to the content based on the comparison.

13. The system of claim 12 wherein the access control module further is to block access to the URL when the associated URL data corresponds with the reference data.

14. The system of claim 12 wherein the web proxy further is to forward a request to the URL when the request is not denied based on the comparison between the associated URL data and the reference data.

15. The system of claim 12 wherein the reference data includes a list of reference key words.

16. The system of claim 12 wherein the associated URL data includes key words associated with the URL.

17. The system of claim 12 wherein the selectively blocking access includes denying a request from a web browser to access the URL.

18. The system of claim 12 wherein the web proxy further is to cache the search result and the associated URL data for subsequent use.

19. The system of claim 12 wherein the reference data includes objectionable content specifiable by an administrator.

20. The system of claim 12 wherein the associated URL data includes at least one selected from a group including a category, class, classification, cognomen, compellation, denomination, description, epithet, identification, key word, label, mark, moniker, naming, nomen, style, title, designation, department, division, grade, group, grouping, head, heading, kind, league, level, list, section, sort, and a type.

21. A system to control access to content accessible via a network, the system comprising:
means for receiving a Uniform Resource Locator (URL);
means for submitting a search request based upon the URL;
means for receiving a search result including associated URL data;
means for comparing the associated URL data with reference data; and
means for selectively denying access to the content based on the comparison.

22. The system of claim 21 wherein the means for receiving the URL, and the search result including the associated URL data, the means for comparing, and the means for selectively denying access are provided at a web proxy coupling a user machine and a network.
